(19) United States
(12) Patent Application Publication
(10) Pub. No.: US 2013/0171841 A1
(43) Pub. Date: Jul. 4, 2013

(54) TEST DEVICE FOR TESTING USB SOCKETS

(71) Applicants: JUI-HSIUNG HO, Tu-Cheng (TW); CHUAN-CHI LIU, Tu-Cheng (TW); CHIH-FENG LO, Tu-Cheng (TW)

(72) Inventors: JUI-HSIUNG HO, Tu-Cheng (TW); CHUAN-CHI LIU, Tu-Cheng (TW); CHIH-FENG LO, Tu-Cheng (TW)

(73) Assignee: HON HAI PRECISION INDUSTRY CO., LTD., Tu-Cheng (TW)

(21) Appl. No.: 13/555,215

(22) Filed: Jul. 23, 2012

(30) Foreign Application Priority Data
Dec. 28, 2011 (TW) 100149371

(51) Int. Cl. H01R 29/00

(52) U.S. Cl. 439/54

(57) ABSTRACT

A test device includes a load module, an input module, an output module, a switching module, and a control module. The load module includes a light electrical load and a heavy electrical load. The input module includes at least one input connector switchably connected to the light load and the heavy load. The output module includes at least one output connector switchably connected to one of the at least one input connector. The switching module is configured to switch a connection between the input connector and the load module, and the connection between the at least one output connector and the at least one input connector. The control module is configured to control the switching module to switch the connections.

### BACKGROUND

1. Technical Field

The present disclosure relates to a test device connected to a voltage recording device and an electronic device with at least one universal serial bus (USB) socket, for testing USB sockets of the electronic device.

2. Description of Related Art

An electronic device, such as a notebook computer, may include a number of USB sockets for connecting with a number of USB devices. The USB socket provides a supply voltage to the USB device, and the USB device represents a load in relation to the USB socket. When one of the USB devices is removed from the electronic device, the output voltage of the USB sockets floats and the floating voltage may cause damage to the electronic device and the USB devices connected to the electronic device.

Thus, a drop test and a droop test may be used to test the USB sockets of the electronic device. In the drop test, one USB socket is connected to a heavy load. When the heavy load is removed from the USB socket, the output voltage of the USB socket floats. In the droop test, one of the USB sockets is connected to a light load, and the other USB sockets are connected to a heavy load. When the light load is removed from the USB socket, the output voltage of the other USB sockets float. Thus, it is necessary to record voltage changes of the USB sockets in the drop test and in the droop test.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram view of a test device according to an exemplary embodiment, wherein the test device is connected to an electronic device with USB sockets and a voltage recording device.

FIG. 2 is a detailed, schematic view of connections between the test device and the USB sockets of the electronic device.

### DETAILED DESCRIPTION

Embodiments of the present disclosure are described with reference to the accompanying drawings.

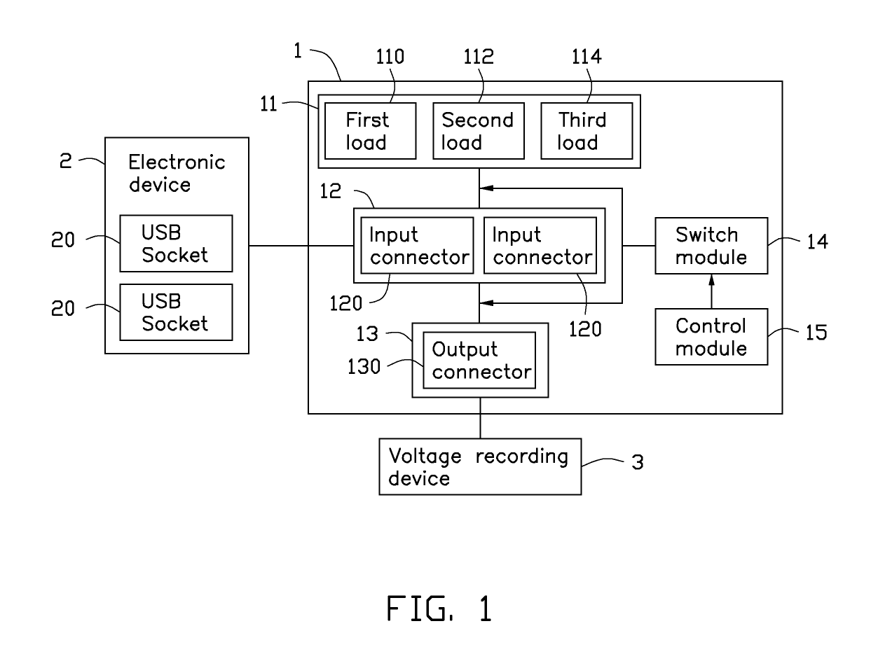

Referring to FIG. 1, a test device 1 according to an exemplary embodiment is illustrated. The test device 1 includes a load module 11, an input module 12 connected to an electronic device 2, an output module 13 connected to a voltage recording device 3, a switch module 14, and a control module 15. The electronic device 2 includes two USB sockets 20. In other embodiments, the electronic device 2 may include one or more that two USB sockets 20. The USB socket 20 includes a VBUS line and a GND line and the nominal voltage therebetween is about 5V.

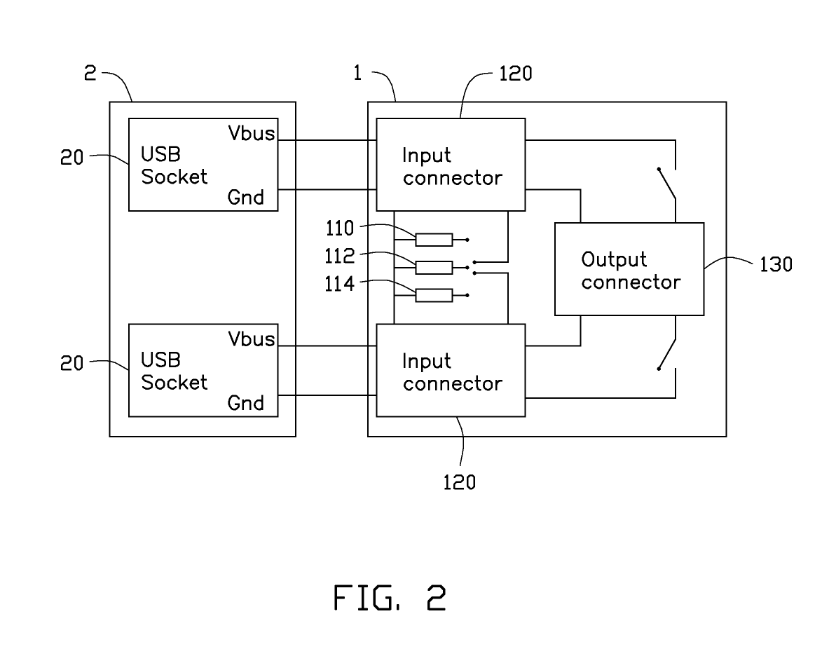

Referring also to FIG. 2, the load module 10 includes a first, negligible load 130, a second, light load 132, and a third, heavy load 134. When the first load 130 is connected to the USB socket 20, the current through the first load 110 is 0 mA. When the second load 112 is connected to the USB socket 20, the current through the second load 112 is about 100 mA. When the third load 124 is connected to the USB socket 20, the current through the third load 130 is about 500 mA.

The input module 12 includes two input connectors 120 each connected to one of the two USB sockets 20 of the electronic device 2. Specifically, the input connectors 120 are connected to the VBUS line and the GND line of the USB sockets 20. The input connectors 120 can be switchably connected to one of the first load 130, the second load 132, and the third load 134.

The output module 13 includes an output connector 130 connected to the voltage recording device 30, e.g., an oscilloscope. The output connector 130 is switchably connected to one of the input connectors 120, and the voltage recording device 30 can thus record voltage changes of the USB socket 20 that is connected to the output connector 130 via the input connector 120.

The switching module 14 is used to switch the connections between the input module 12 and the load module 11, and the connections between the output module 13 and the input module 12. In detail, the switching module 14 can switch the input connector 120 to connect with any of the first load 110, the second load 112, and the third load 114. Also, the switching module 14 can switch the output connector 130 to connect with any of the input connectors 120.

The control module 15 is configured to control the switching module 14 to switch the connections.

In the drop test, one input connector 120 is connected to the third load 114, and the output connector 130 is connected to the input connector 120 that connects with the third load 114. The control module 15 controls the switching module 14 to switch the input connector 120 to connect with the first load 110, thereby simulating the removal of a USB device (not shown) from the USB socket 20. Therefore, the voltage recording device 30 can thus record voltage changes of the USB socket 20 in the drop test.

In the droop test, one input connector 120 is connected to the second load 112, the other one input connector 120 is connected to the third load 114, and the output connector 130 is connected to the input connector 120 that connects with the third load 114. The control module 15 controls the switching module 14 to switch the input connector 120 that connects the second load 112 to connect with the first load 110, thereby simulating the removal of a USB device from the USB sockets 20. Therefore, the voltage recording device 30 can thus record voltage changes of the USB socket 20 that connects with the third load 114 in the droop test.

The test device 1 can record voltage changes of the other USB socket(s) 20 of the electronic device 2 in the drop test and the droop test using the way described above. Thus, the voltage recording device 3 can obtain voltage changes of all the USB sockets 20 in the drop test and the droop test.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A test device connected to an electronic device with at least one USB socket, the test device comprising:
a load module comprising an negligible load and a heavy load;
an input module comprising at least one input connector connected to the at least one USB socket of the electronic device, the at least one input connector being switchably connected to one of the negligible load and the heavy load;
an output module comprising at least one output connector switchably connected to one of the at least one input connector;
a switching module configured to switch a connection between the input connector and the load module, and the connection between the at least one output connector and the at least one input connector; and
a control module configured to control the switching module to switch the connections.

2. The test device as described in claim 1, wherein when the at least one input connector is connected to the heavy load, the current through the heavy load is about 500 mA.

3. The test device as described in claim 1, wherein the load module further comprises a light load, and when the at least one input connector is connected to the light load, the current through the light load is about 100 mA.
